(19) United States
(12) Patent Application Publication
(10) Pub. No.: US 2011/0198887 A1
(43) Pub. Date: Aug. 18, 2011

(54) DOUBLE-ACTING PISTON COMPRESSOR OF WHICH THE PISTON IS GUIDED BY A ROLLER AND DRIVEN BY A PINION AND RACKS

(76) Inventor: Vianney RABHI, LYON (FR)

(21) Appl. No.: 13/029,142

(22) Filed: Feb. 17, 2011

Related U.S. Application Data
(60) Provisional application No. 61/306,079, filed on Feb. 19, 2010.

(30) Foreign Application Priority Data
Feb. 17, 2010 (FR) 1000655

(51) Int. Cl. B60R 16/08; F04B 35/01; F04B 17/05; F02B 33/06; F04B 1/00; F04B 23/14

(52) U.S. Cl. 296/193.01; 91/462; 417/321; 123/559.1; 91/508; 417/203; 417/374

(57) ABSTRACT

A double-acting piston compressor (1) includes at least one cylinder (3) in which a double-acting piston (4) moves, the cylinder (3) and the piston (4) jointly defining an upper chamber (5) and a lower chamber (6) each provided with at least one intake duct (7) and at least one delivery duct (8), and each duct including at least one valve (90, 91), and a linking rod (10) connecting the double-acting piston (4) to a transmission member (11) collaborating, on the one hand, with a guide roller (12) and, on the other hand, with a pinion (15), at least one anchoring member (22) collaborating with the pinion (15), a connecting rod (25) to which the pinion (15) is articulated by a pivot pin (26), the connecting rod (25) being connected to the crank (28) of a crankshaft (27) housed in bearings formed in the compressor casing (2).

The present invention relates to a double-acting piston compressor of which the piston is guided by a roller and driven by a pinion and racks.

Reciprocating piston compressors are usually equipped with a single-acting piston moved by a connecting rod—crank assembly similar to that used in reciprocating internal combustion engines. Some reciprocating piston compressors are, however, equipped with one or more double-acting piston(s).

The cylinder and the piston of this type of compressor together define an upper chamber and a lower chamber, said piston comprising a lower rod which imparts its translational movement to it and plays a part in orienting it, said rod being itself connected to a crosshead or to a trunk piston which provides it with translational guidance and connects it to a connecting rod by means of a pivot joint.

Double-acting piston compressors offer excellent efficiency because the gas is drawn in and discharged simultaneously by one and the same piston the upper face and underside face of which are active. This can potentially make it possible to limit the number of cylinders, to reduce the compressor operating speed for the same duty and to increase the mechanical efficiency of said compressor by a relative reduction in friction losses.

The crosshead or the trunk piston that double-acting piston compressors comprise makes it possible to eliminate the radial force ordinarily applied by the connecting rod to the piston of single-acting piston compressors because it is the connection between said crosshead and its guide or said trunk piston and its cylinder which experiences the transverse forces generated by the connecting rod.

However, what this configuration does not do is avoid friction between the crosshead and its guide or between the trunk piston and its cylinder. Furthermore, double-acting reciprocating piston compressors have the disadvantage of a substantial vertical height and of a high reciprocating mass.

These shortcomings are the main reasons why single-acting or double-acting piston compressors are not used to supercharge internal combustion car engines. The main application to reciprocating internal combustion engines that has been attempted is attributed to “Berliet” and dates back to the beginning of the twentieth century.

The positive-displacement compressors used nowadays for supercharging car engines are mainly “Roots” lobed compressors, “Lysholm” screw-type compressors, rotary piston type compressors using the “Wankel” principle, “Zoller” or “Cozette” vane-plus-eccentric-rotor type compressors or scroll compressors of the “G-Lader” type like those once used by Volkswagen on some of its models.

The supercharging device that dominates the internal combustion car engine market is the centrifugal turbocompressor because of its simplicity of installation and because powering it makes use of the gas expansion tail, which tail is ordinarily lost to the exhaust in a supercharged engine fitted with a mechanical compressor driven off the crankshaft.

By contrast, turbocompressors or turbochargers have the disadvantage of a response time which is troublesome to the driver of the vehicle, of an inability to produce high torques across the entire speed range unless a number of turbochargers are provided, and of being highly sensitive to the temperature of the exhaust gases which has not to exceed the limit that is acceptable to the turbine.

Another disadvantage of turbocompressors is the increase in exhaust back pressure which limits the possibilities of scavenging the charge contained in the combustion chamber of the engine and which complicates the design and development of exhaust gas recirculation devices.

Another disadvantage of turbocompressors is the insertion of a turbine and its casing between the exhaust outlets of the engine and the catalytic converter that performs post-treatment on the polluting substances emanating from said engine, because this insertion has the effect of lengthening the light-off time of said catalytic converter because said catalytic converter comes up to temperature more slowly.

Although this is not something that is done at the present time, supercharging reciprocating internal combustion engines using a double-acting piston compressor would therefore be advantageous in a number of respects.

Specifically, just like all the positive-displacement compressors, piston compressors have the advantage over centrifugal turbocompressors that they have practically no response time. This stems from the ability of positive-displacement compressors to supply the internal combustion engine immediately with an intake pressure that is higher than atmospheric pressure.

Further, a double-acting piston produces a puff of compressed air on each half revolution: this feature allows the intake of the internal combustion engine to be supplied with a near-constant pressure, once the puffs have been damped and filtered by the intake plenum and/or an additional volumetric capacity.

This special feature allows a double-acting piston compressor to be mounted directly on the crankshaft of the internal combustion engine via an additional crank thus obviating the need for any other transmission device.

This configuration may be particularly suitable for short in-line two-cylinder, three-cylinder or four-cylinder internal combustion engines to which is added a double-acting piston compressor cylinder of individual swept volume that in most cases is greater than that of the engine cylinders of said internal combustion engine so that the desired intake pressure can be achieved over the entire speed range.

Another advantage of supercharging internal combustion engines using a double-acting piston compressor mounted directly on the crankshaft of said engines is that it reduces cost and space.

Specifically, the supercharging effect produced by an additional positive-displacement compressor and/or by a turbocompressor is fully or partially replaced by said double-acting piston compressor.

The fact that there are no longer any additional equipments to be mounted on the internal combustion engines results in an appreciable space saving in the engine compartment of the vehicle, even when the lengthening of the internal combustion engine which then incorporates at least one compressor cylinder is taken into consideration.

This configuration of a double-acting piston compressor mounted on the crankshaft of the internal combustion engines does, however, entail reducing the vertical height of said compressors and maximizing the mechanical efficiency thereof.

Furthermore, numerous applications that entail compressing a gas can benefit from the use of a double-acting piston compressor which is compact, lightweight, and has low friction losses.

It is therefore in order to limit the vertical height of double-acting piston compressors, in order to increase the mechanical efficiency thereof, and in order to reduce their total mass that the object of the present invention is to replace the crosshead or the trunk piston ordinarily provided in said double-acting piston compressors by a racks and pinion transmission device collaborating with a guide roller.

The double-acting piston compressor according to the present invention further proposes offsetting the axis of the crankshaft with respect to the cylinder so that the amplitude of the vertical movement of the connecting rod will now, for example, equate to just half the amplitude of the vertical movement of the piston.

This measure makes it possible greatly to reduce the height of the connecting rod—crank assembly for the same piston stroke and therefore greatly to reduce the vertical height of the double-acting piston compressor.

Further, offsetting the axis of the crankshaft allows the rod which ordinarily connects the piston to a crosshead or to a trunk piston to move mainly next to the connecting rod rather than above it, and this is a second way of reducing the vertical height of the double-acting piston compressor according to the present invention.

In addition, the double-acting piston compressor according to the present invention allows the sliding of the crosshead or of the trunk piston to be replaced by the rolling of a guide roller, and this significantly reduces the mechanical friction losses of said double-acting piston compressor.

The double-acting piston compressor according to the present invention nonetheless makes it possible to retain the advantage of a zero or extremely low radial force applied to the double-acting piston.

Thus, the double-acting piston compressor according to the present invention, of which the piston is guided by a guide roller and driven by a pinion and racks, differs from the prior art in that, according to one particular embodiment:
the radial forces that the pistons of single-acting compressors ordinarily experience are eliminated, notably allowing durable operation of the piston and of its cylinder, even in the absence of lubricating oils;
the vertical height of the compressor is limited despite the presence of two compression chambers such as those delimited by the double-acting piston, and this broadens the scope for applying double-acting piston compressors, notably to the supercharging of car engines;
the mechanical friction of the double-acting piston compressors is reduced and their mechanical efficiency is increased.

The double-acting piston compressor of which the piston is guided by a roller and driven by a pinion and racks according to the present invention applies to any type of use including the supercharging of internal combustion engines.

The double-acting piston compressor of which the piston is guided by a roller and driven by a pinion and racks according to the present invention comprises:
at least one cylinder in which a double-acting piston moves, said cylinder being borne by a compressor casing and each of its ends being closed by a cylinder head, said cylinder and said piston jointly defining an upper chamber and a lower chamber each provided with at least one intake duct and at least one delivery duct, and each duct comprising at least one valve;
a linking rod which connects the double-acting piston to a transmission member, said transmission member collaborating, on the one hand, with a guide roller by means of at least one running surface and by means of at least one small-sized synchronizing rack and, on the other hand, with a pinion by means of at least one large-sized transmission rack and by means of at least one runway strip positioned near the pitch circle of said large-sized transmission rack;
at least one runway strip fixed onto or formed on the pinion, said runway strip being positioned near the pitch circle of said pinion;
at least one guidance runway track fixed to the compressor casing level with the pinion and along which the guide roller rolls;
at least two small pinions positioned one at each of the two ends of the guide roller and which collaborate with small-sized racks positioned one on each side of the guidance runway track fixed to the compressor casing, one of the two small pinions at least also collaborating with the small-sized synchronizing rack that the transmission member comprises;
at least one anchoring member fixed to the compressor casing, said anchoring member collaborating with the pinion by means of at least one large-sized anchoring rack and by means of at least one runway strip positioned near the pitch circle of said large-sized anchoring rack;
a connecting rod to the small end of which the pinion is articulated by means of a pivot pin and the big end of which is connected to the crank of a crankshaft housed in bearings formed in the compressor casing.

The double-acting piston compressor according to the present invention comprises a piston of which the part in contact with the cylinder has a spherical profile that allows said piston to be oriented in said cylinder.

The double-acting piston compressor according to the present invention comprises a double-acting piston having at least one piston ring or one seal which seals it against the cylinder.

The double-acting piston compressor according to the present invention comprises a double-acting piston having raised patterns which create a pressure drop on the cylindrical part of said piston.

The double-acting piston compressor according to the present invention comprises a cylinder of which the interior surface comprises raised patterns which create a pressure drop.

The double-acting piston compressor according to the present invention comprises a double-acting piston which is fixed to the end of the linking rod by means of a ball joint.

The double-acting piston compressor according to the present invention comprises a linking rod having at least one ring or one seal which seals it against the cylinder head of the lower chamber of the compressor.

The double-acting piston compressor according to the present invention comprises a linking rod having at least one ring or one seal which seals it against the compressor casing.

The double-acting piston compressor according to the present invention comprises an anchoring member having an upper or lower anchoring rod the end of which is fixed to the compressor casing.

The double-acting piston compressor according to the present invention comprises an anchoring member which is fixed to the compressor casing by means of a ball joint.

The double-acting piston compressor according to the present invention comprises a ball joint which is positioned above or below the anchoring member.

The double-acting piston compressor according to the present invention comprises an anchoring member comprising stiffening webs on each side of its large-sized anchoring rack.

The double-acting piston compressor according to the present invention comprises an anchoring member which is fixed to the compressor casing by means of a joint that has two perpendicular pivot pins of the Hooke's joint type.

The double-acting piston compressor according to the present invention comprises an anchoring member which is fixed to the compressor casing by means of a component with two offset perpendicular pivot pins, the first pivot pin being articulated to said anchoring member, while the second pivot pin is articulated to the compressor casing.

The double-acting piston compressor according to the present invention comprises a component that has two offset perpendicular pivot pins of which the second pivot pin comprises a limit stop that allows adjustment of the verticality of the anchoring member.

The double-acting piston compressor according to the present invention comprises a limit stop which allows adjustment of the verticality of the anchoring member and which is screwed into the compressor casing and prevented from turning by locking means.

The double-acting piston compressor according to the present invention comprises an anchoring member comprising means of adjusting its vertical position with respect to the compressor casing.

The double-acting piston compressor according to the present invention comprises a runway strip of the anchoring member which is kept in contact with the runway strip of the pinion by a pressure-maintaining device.

The double-acting piston compressor according to the present invention comprises a pressure-maintaining device which consists of a spring.

The double-acting piston compressor according to the present invention comprises a pressure-maintaining device which consists of a pressing actuator connected to a pressure accumulator.

The double-acting piston compressor according to the present invention comprises a pinion which has a truncated profile defining two toothed sectors.

The double-acting piston compressor according to the present invention comprises a pinion having weight-saving pockets and stiffening ribs.

The double-acting piston compressor according to the present invention comprises a pivot pin by means of which the pinion is articulated to the small end of the connecting rod which is housed in bores formed in said pinion on each side of a recess, said recess housing the small end of the connecting rod.

The double-acting piston compressor according to the present invention comprises a pivot pin by means of which the pinion is articulated to the small end of the connecting rod and which is housed in bores formed in a fork that forms the small end of the connecting rod, said pinion being housed in the crook of said fork.

The double-acting piston compressor according to the present invention comprises a transmission member comprising stiffening webs on each side of its large-sized transmission rack.

The double-acting piston compressor according to the present invention comprises a guidance runway track and small-sized racks positioned on each side of said track which are borne by a synchronizing plate fixed to the compressor casing.

The double-acting piston compressor according to the present invention comprises at least one adjusting shim which is inserted between the synchronizing plate and the compressor casing.

The double-acting piston compressor according to the present invention is mounted on a fixed compression ratio or variable compression ratio internal combustion engine

The double-acting piston compressor according to the present invention comprises a crankshaft of the compressor which is produced in the continuation of the crankshaft of an internal combustion engine and forms an integral part thereof.

The double-acting piston compressor according to the present invention comprises delivery ducts of the compressor which are connected to the intake ducts of the internal combustion engine.

5

The double-acting piston compressor according to the present invention comprises a compressor casing which is attached to the crankcase of the internal combustion engine.

The double-acting piston compressor according to the present invention comprises a compressor casing which forms an integral part of the crankcase of the internal combustion engine.

The double-acting piston compressor according to the present invention comprises a cylinder, cylinder heads and intake and delivery ducts which are fully or partially incorporated into the cylinder head of the internal combustion engine.

The double-acting piston compressor according to the present invention comprises a cylinder, cylinder heads and intake and delivery ducts which are fully or partially incorporated into the crankcase of the internal combustion engine.

The double-acting piston compressor according to the present invention comprises a compressor casing comprising a cooling water circuit connected to that of the internal combustion engine.

The double-acting piston compressor according to the present invention comprises delivery ducts comprising a redirection valve which places them fully or partially in communication with a reserve of compressed air.

The double-acting piston compressor according to the present invention comprises a reserve of compressed air which consists of structural elements of the bodywork of a motor vehicle, said structural elements being rendered airtight.

The double-acting piston compressor according to the present invention comprises a reserve of compressed air which is connected to the intake of the internal combustion engine by a large-diameter duct that can be opened or closed by means of a large bore section valve.

The double-acting piston compressor according to the present invention comprises a reserve of compressed air comprising a compressed air tapping.

The double-acting piston compressor according to the present invention comprises delivery ducts of the compressor comprising a redirection valve which places them fully or partially in communication with a pressure drop housing.

The double-acting piston compressor according to the present invention comprises intake ducts of the compressor comprising at least one throttling butterfly.

The double-acting piston compressor according to the present invention comprises delivery ducts comprising at least one throttling butterfly.

The double-acting piston compressor according to the present invention comprises valves comprising an impact damper and/or limiter.

The double-acting piston compressor according to the present invention comprises an impact damper and/or limiter which consists of an elastic link between the body of the valve and the bearing surface via which the valve shutter rests against its seat.

The double-acting piston compressor according to the present invention comprises an inter-piston linking rod which connects the double-acting pistons of each cylinder of the compressor, the next double-acting piston defining, with its cylinder, its intake and delivery ducts and its valves, a new compressor stage mounted in series or in parallel with the stage before it.

The double-acting piston compressor according to the present invention comprises intake ducts comprising at least one boost valve positioned upstream of and a certain distance away from the valve.

The double-acting piston compressor according to the present invention comprises intake ducts which are connected to the outlet of a centrifugal or rotary compressor.

The double-acting piston compressor according to the present invention comprises a centrifugal compressor which is driven by an electric motor.

The double-acting piston compressor according to the present invention comprises a centrifugal compressor which is driven by a turbine driven by the exhaust gases from an internal combustion engine.

The double-acting piston compressor according to the present invention comprises a double-acting piston comprising a sealing rim mounted radially free between at least two flanges.

The double-acting piston compressor according to the present invention comprises a double-acting piston of which the sealing rim has raised patterns which create a pressure drop on its external cylindrical part.

The double-acting piston compressor according to the present invention comprises a double-acting piston of which the sealing rim comprises at least one upper seal and/or one lower seal creating a seal between said rim and the flanges between which it is mounted.

The double-acting piston compressor according to the present invention comprises a double-acting piston comprising a stack of sealing washers, said stack being mounted radially free between at least two flanges.

The double-acting piston compressor according to the present invention comprises a double-acting piston of which the sealing washers have raised patterns which create a pressure drop on their external cylindrical part.

The double-acting piston compressor according to the present invention comprises a double-acting piston of which the first and/or the last sealing washer comprises (comprise) at least one seal creating a seal between said washer and the flange with which it is in contact.

The double-acting piston compressor according to the present invention comprises a double-acting piston comprising at least one dynamic seal at its periphery, of which the distance away from the cylinder is slaved to the pressure obtaining in the upper or lower chamber, said dynamic seal being able to come into contact with the cylinder when the pressure in the chamber that is to be sealed is high enough.

The double-acting piston compressor according to the present invention comprises a double-acting piston of which the dynamic seal comprises an air chamber connected to one or other of the chambers by at least one duct, said air chamber being able to apply a pressure to the internal cylindrical face of a constrictor ring and said constrictor ring then being able to push a lip seal toward the surface of the cylinder until contact between said lip seal and said cylinder is assured.

The double-acting piston compressor according to the present invention comprises a double-acting piston of which the constrictor ring or the dynamic seal has a cut which comprises a limit stop that limits the maximum diameter of said constrictor ring.

The double-acting piston compressor according to the present invention comprises a double-acting piston of which the dynamic seal consists of a torus made of a flexible material housed in a groove with the upper and lower faces of which it forms a seal, the space between the back of the groove and said torus or inside said torus being connected to one or other of the chambers by at least one duct and said torus being able to push a lip seal toward the surface of the cylinder until contact between said lip seal and said cylinder is assured.

The double-acting piston compressor according to the present invention comprises a double-acting piston of which the dynamic seal consists of a toroidal bladder made of a flexible material housed in a groove, said bladder being connected to one or other of the chambers by at least one duct so that it can inflate under the effect of the pressure so as to come into contact with the cylinder.

The double-acting piston compressor according to the present invention comprises a double-acting piston of which the bladder of the dynamic seal on its exterior periphery comprises small holes through which air under pressure can exit so as to constitute an air cushion to prevent direct contact between said bladder and the cylinder.

The double-acting piston compressor according to the present invention comprises a double-acting piston of which the linking rod collaborates with a guide device positioned inside and/or under the cylinder head which closes the lower end of the cylinder, said guide device providing the radial positioning and axial orientation of said linking rod.

The double-acting piston compressor according to the present invention comprises a double-acting piston of which the linking rod is connected to the transmission member by a ball joint.

The double-acting piston compressor according to the present invention comprises a pinion of which the pivot pin comprises a ball joint allowing said pinion to self-orient freely about any one of the three axes of an orthonormal Cartesian frame of reference.

The double-acting piston compressor according to the present invention comprises a cylinder comprising a temperature equalizing chamber consisting of a space between a tube in which the double-acting piston moves and an external casing, said space containing a heat transfer substance.

The double-acting piston compressor according to the present invention comprises delivery ducts which are connected to the intake duct(s) of the internal combustion engine via a calming device consisting of at least one calming volume comprising at least one non return valve.

The double-acting piston compressor according to the present invention comprises a pinion, a transmission member, an anchoring member, a guide roller and a connecting rod which are situated diametrically on the opposite side of the double-acting piston, of the cylinder and of the cylinder heads from the crankshaft, the linking rod being long enough to connect said transmission member to said piston in spite of the longer distance resulting from this configuration.

The double-acting piston compressor according to the present invention comprises a transmission between the double-acting piston compressor and the internal combustion engine which is provided by rotational transmission means consisting of at least a chain and/or at least a belt and/or at least two pinions or sprockets.

The double-acting piston compressor according to the present invention can be temporarily disconnected from the internal combustion engine by means of a clutch positioned before or after the rotational transmission means.

The double-acting piston compressor according to the present invention comprises at least one balance shaft.

The double-acting piston compressor according to the present invention comprises at least one balance weight connected to the crankshaft by at least one balance rod, said balance rod being articulated about the crankshaft by means of a crank which is offset by 180 degrees with respect to the crank to which the connecting rod of the compressor is articulated.

The double-acting piston compressor according to the present invention comprises a balance weight which is connected to the casing of the compressor by at least one small anchor rod so as to keep its movement approximately parallel to the axis of the cylinder of said compressor.

The double-acting piston compressor according to the present invention comprises at least one bypass valve allowing connection between inlet (E) and outlet (S) ducts into which the intake and delivery ducts respectively open.

The double-acting piston compressor according to the present invention comprises at least one bypass valve allowing connection between the delivery duct of the upper chamber and the intake duct of the lower chamber.

The double-acting piston compressor according to the present invention comprises at least one bypass valve allowing connection between the delivery duct of the lower chamber and the intake duct of the upper chamber.

The double-acting piston compressor according to the present invention comprises at least one bypass valve allowing connection between the delivery duct of the lower chamber and the intake duct of said lower chamber.

The double-acting piston compressor according to the present invention comprises at least one bypass valve allowing connection between the delivery duct of the upper chamber and the intake duct of said upper chamber.

The double-acting piston compressor according to the present invention comprises at least one isolation valve allowing the intake duct of the upper chamber and/or of the lower chamber to be closed off.

The double-acting piston compressor according to the present invention comprises a double-acting piston of which the linking rod collaborates with a labyrinth seal which provides a seal between the lower chamber and the intake duct of said chamber or between said lower chamber and the inside of the compressor casing.

The description which will follow with reference to the attached drawings given by way of non-limiting examples will provide a better understanding of the invention, of its features and of the advantages it is able to afford:

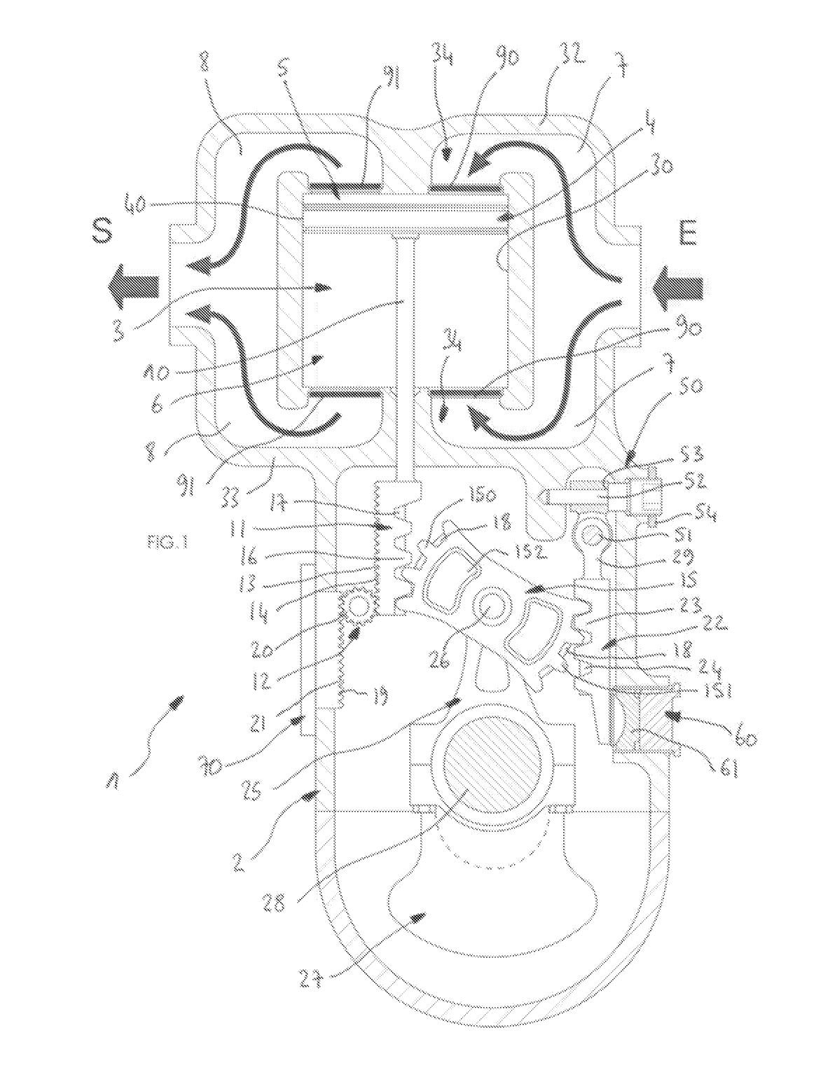

FIG. 1 is a view in cross section illustrating the main components of a double-acting piston compressor of which the piston is guided by a roller and driven by a pinion and racks according to the present invention.

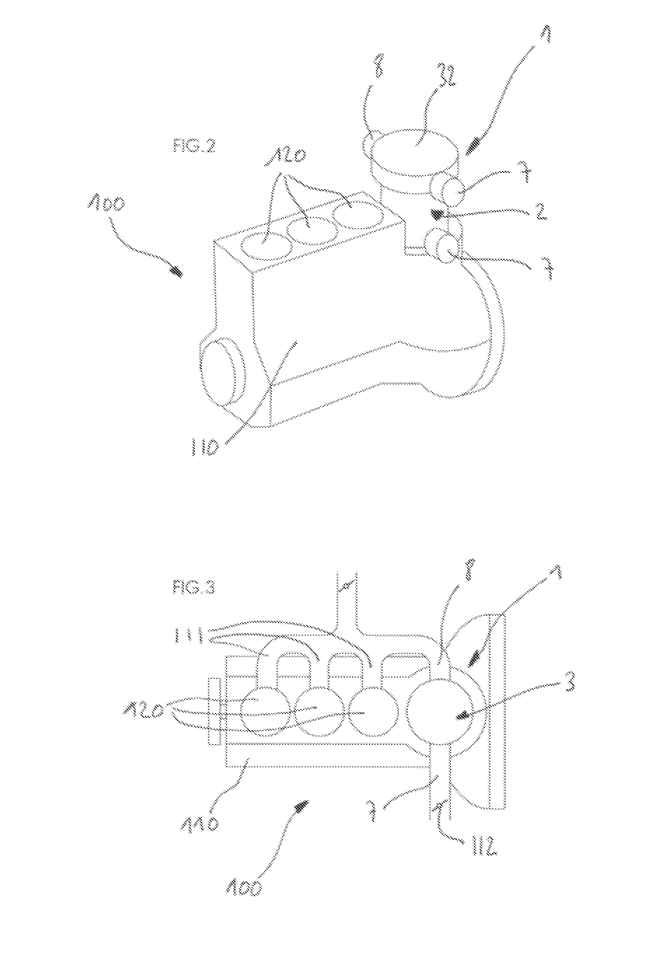

FIGS. 2 and 3 are schematic views depicting the double-acting piston compressor of which the piston is guided by a roller and driven by a pinion and racks mounted on an internal combustion engine according to the present invention.

FIG. 4 is a view in cross section depicting an alternative form of the double-acting piston compressor of which the piston is no longer guided by the cylinder but is guided by the linking rod according to the present invention.

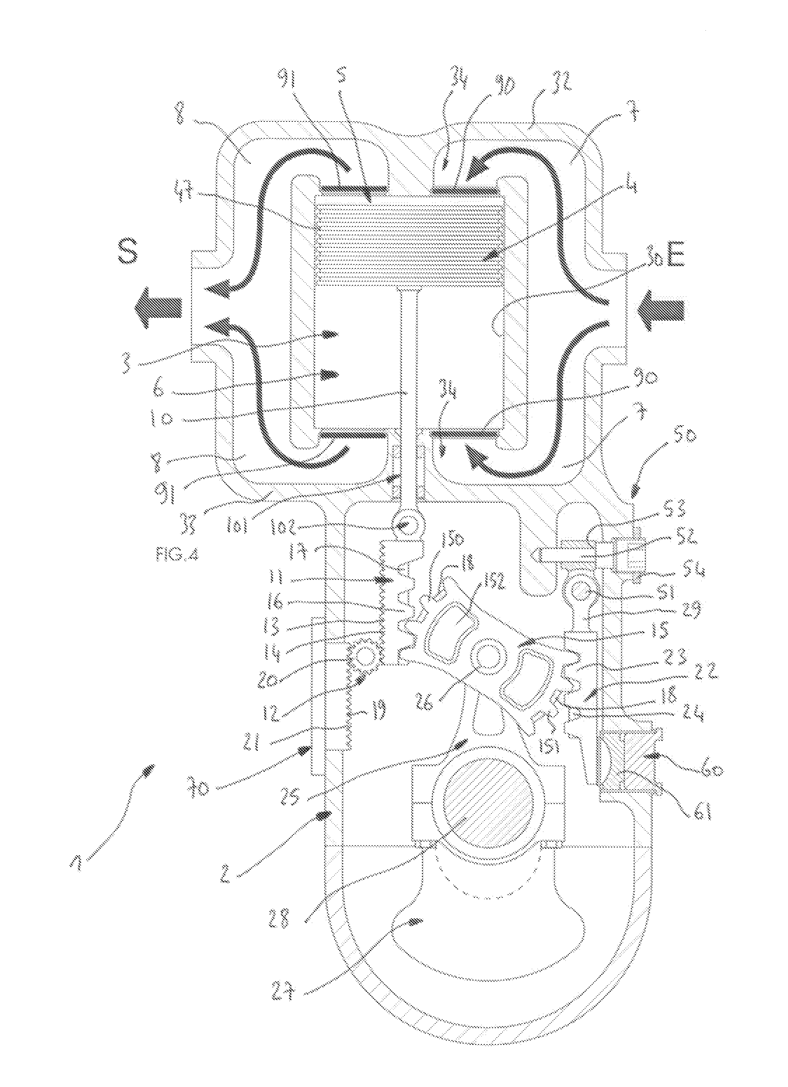

FIGS. 5 to 9 are views illustrating alternative forms of embodiment of the sealing device of the double-acting piston according to the present invention.

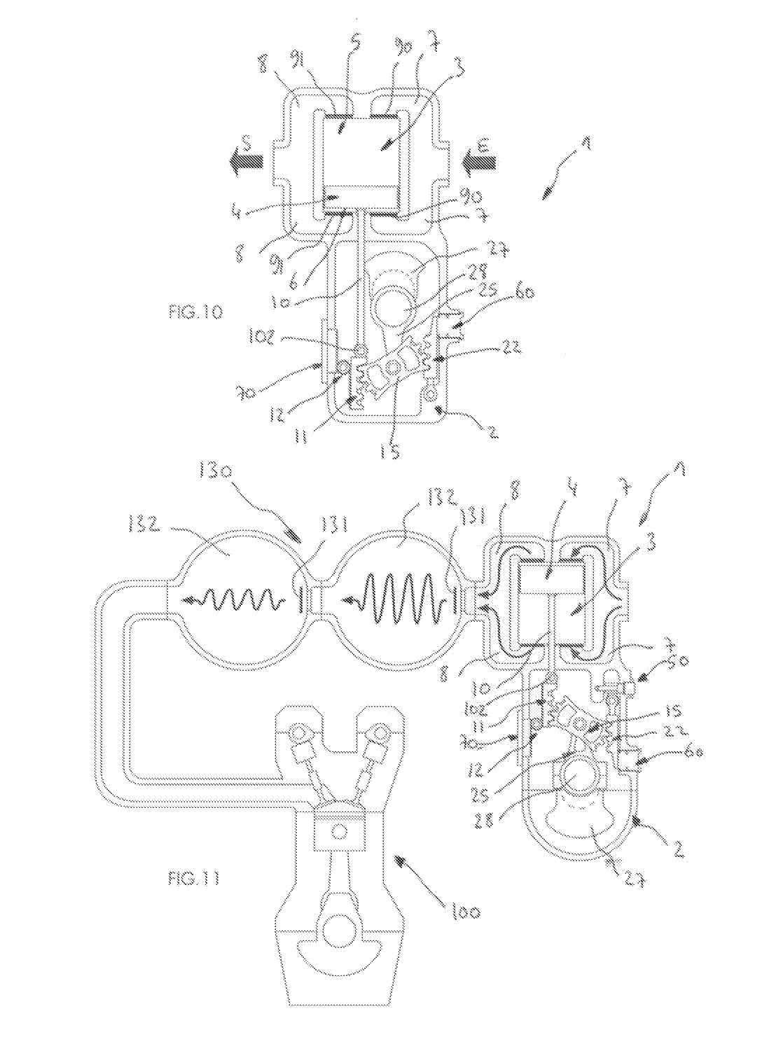

FIG. 10 is a schematic view depicting an alternative form of the double-acting piston compressor in which all the transmission elements are situated diametrically on the opposite side of the double-acting piston (4), of the cylinder (3) and of the cylinder heads (32, 33) from the crankshaft (27) according to the present invention.

FIG. 11 is a schematic view showing calming volumes mounted on the outlet side of the double-acting compressor and connected to one another by non return valves according to the present invention.

FIGS. 12 to 16 are schematic views illustrating various configurations for fitting a bypass valve of the double-acting compressor according to the present invention.

FIG. 17 is a perspective view depicting balance weights connected by their balance rod to the crankshaft of the double-acting compressor according to the present invention.

### DESCRIPTION OF THE INVENTION

FIG. 1 depicts a double-acting piston compressor 1 comprising a compressor casing 2 provided with at least one cylinder 3 in which a double-acting piston 4 moves.

The cylinder 3 is closed at each of its ends by a cylinder head 32, 33 so that said cylinder 3 and the piston 4 together define an upper chamber 5 and a lower chamber 6 each equipped with at least one intake duct 7 and with at least one delivery duct 8 each provided with at least one valve 90, 91.

Each valve 90, 91 may, according to other embodiments, be replaced by a poppet-type valve, a slide valve or any other device that allows the intake 7 and delivery 8 ducts to be opened and shut off cyclically.

The valves 90, 91 comprise an impact damper and/or limiter which for example consists of an elastic link between the body of the valve and the bearing surface via which the valve shutter rests against its seat.

That part of the piston 4 that is in contact with the cylinder 3 has a spherical profile 40 which allows said piston to be oriented in said cylinder.

The double-acting piston 4 has at least one piston ring or one seal, not depicted, which seals it against the cylinder 3.

The double-acting piston 4 comprises raised patterns 47 which create a pressure drop on its cylindrical part (FIG. 4).

The interior surface 30 of the cylinder comprises raised patterns which create a pressure drop.

The double-acting piston 4 is connected via a linking rod 10 to a transmission member 11. The double-acting piston 4 may be fixed to the end of the linking rod 10 by means of a ball joint, not depicted.

The linking rod 10 comprises at least one ring or one seal, not depicted, which seals it against the compressor casing 2 and/or against the cylinder head 33 of the lower chamber 6 of the compressor 1.

It will be noted that, according to one particular embodiment, the seal may be similar to internal combustion engine valve stem seals to prevent oil contained in the compressor casing 2 from traveling up inside the intake valve box 34 that the lower cylinder head 33 of said compressor 1 comprises.

It will be noted that this seal may collaborate with a sealing ring, not depicted, which prevents the gas contained in the lower chamber 6 of the compressor 1 from leaking into said intake valve box 34.

The transmission member 11 collaborates, on the one hand, with a guide roller 12 by means of at least one running surface 13 and by means of at least one small-sized synchronizing rack 14 and, on the other hand, with a pinion 15 by means of at least one large-sized transmission rack 16 and by means of at least one runway strip 17 positioned near the pitch circle of said large-sized transmission rack 16.

The pinion 15 comprises at least one runway strip 18 which is positioned near the pitch circle of said pinion. The runway strip 18 may be fixed onto or formed on the pinion 15.

The compressor casing 2 comprises, level with the pinion 15, at least one guidance runway track 19 along which the guide roller 12 rolls.

The guide roller 12 comprises at each end at least two small pinions 20 which collaborate with small-sized racks 21 positioned one on each side of the guidance runway track 19 fixed to the compressor casing 2.

At least one of the two small pinions 20 of the guide roller 12 also collaborates with the small-sized synchronizing rack 14 that the transmission member 11 comprises.

The transmission member 11 comprises stiffening webs, not depicted, positioned one on each side of its large-sized transmission rack 16.

It will be noted that the center of gravity of the assembly made up of the piston 4, the linking rod 10 and the transmission member 11, needs to be positioned as close as possible to the pitch circle of the large-sized transmission rack 16.

The guidance runway track 19 and the small-sized racks 21 positioned on each side of said track are borne by a synchronizing plate 70 fixed to the compressor casing 2.

It will be noted that at least one adjusting shin may be inserted between the synchronizing plate 70 and the compressor casing 2 permitting adjustment of the verticality of the transmission member 11 and thus limiting the excursion of said member with respect to the cylinder 3 of the compressor 1.

The pinion 15, on the opposite side to the large-sized transmission rack 16 of the transmission member 11, collaborates with at least one anchoring member 22 fixed to the compressor casing 2.

The anchoring member 22 collaborates with the pinion 15 by means of at least one large-sized anchoring rack 23 and by means of at least one runway strip 24 positioned near the pitch circle of said anchoring rack.

The anchoring member 22 comprises stiffening webs on each side of its large-sized anchoring rack 23.

The pinion 15 is articulated by means of a pivot pin 26 to the small end of a connecting rod 25, the big end of which is connected to the crank 28 of a crankshaft 27 housed in bearings formed in the compressor casing 2.

The pivot pin 26 by means of which the pinion 15 is articulated to the small end of the connecting rod 25 can be housed in bores formed in said pinion on each side of a recess, said recess housing the small end of the connecting rod 25.

The pivot pin 26 by means of which the pinion is articulated to the small end of the connecting rod 25 may be housed in bores formed in a fork, not depicted, which forms the small end of the connecting rod, said pinion being housed in the crook of said fork.

The pinion 15 has a truncated profile defining two toothed sectors 150, 151 respectively collaborating with the large-sized transmission rack 16 of the transmission member 11 and with the large-sized anchoring rack 23 of the anchoring member 22.

The pinion 15 comprises weight-saving pockets 152 and stiffening ribs, not depicted.

The anchoring member 22 comprises an upper or lower anchoring rod 29 the end of which is fixed to the compressor casing 2 by means either of a ball joint or of a joint that has two perpendicular pivot pins of the Hooke's joint type positioned above or below said anchoring member.

In our exemplary embodiment, the anchoring member 22 is fixed to the compressor casing 2 by means of a component 50 with two offset perpendicular pivot pins, the first pivot pin 51 being articulated to said anchoring member 22, while the second pivot pin 52 is articulated to the compressor casing 2.

The second pivot pin 52 of the component 50 that has two offset perpendicular pivot pins comprises a limit stop 53 that allows adjustment of the verticality of the anchoring member 22.

The limit stop 53 that allows adjustment of the verticality of the anchoring member 22 is screwed into the compressor casing 2 and prevented from turning by locking means 54.

The anchoring member 22 comprises means, not depicted, of adjusting its vertical position with respect to the compressor casing 2.

The runway strip 24 of the large-sized anchoring rack 23 of the anchoring member 22 is kept in contact with the runway strip 18 of the pinion 15 by a pressure-maintaining device 60.

The pressure-maintaining device 60 may for example consist either of a spring or of a pressing actuator 61 connected to a pressure accumulator.

FIGS. 2 and 3 depict the double-acting piston compressor 1 according to the present invention mounted on a fixed compression ratio or variable compression ratio internal combustion engine 100.

In this particular arrangement, the compressor casing 2 may be either attached to the crankcase 110 of the fixed compression ratio or variable compression ratio internal combustion engine 100, or incorporated into said crankcase 110.

It will be noted that all or part of the cylinder 3, of the cylinder heads 32, 33 and of the intake 7 and delivery 8 ducts of the compressor 1 form an integral part of the cylinder head of the internal combustion engine 100.

According to another embodiment, all or part of the cylinder 3, of the cylinder heads 32, 33 and of the intake 7 and delivery 8 ducts of the compressor 1 form an integral part of the crankcase 110 of the internal combustion engine 100.

Also, the crankshaft 27 of the double-acting piston compressor 1 is produced in the continuation of the crankshaft of the internal combustion engine 100 and forms an integral part thereof.

The delivery ducts 8 of the double-acting piston compressor 1 are connected to the intake duct(s) 111 of the internal combustion engine 100.

It will be noted that the intake duct(s) 111 of the internal combustion engine 100 may comprise a heat exchanger aimed at cooling the air admitted by the engine, and possibly a calming chamber or active or passive filters aimed at limiting the amplitude of the pressure waves present in said intake duct(s).

It will be noted also that throttling devices on the inlet side of each cylinder 120 of the internal combustion engine 100 may be provided with a view to evening out the level of filling of said cylinders, said throttling devices operating together or independently of one another.

The compressor casing 2 comprises a cooling water circuit connected to that of the internal combustion engine 100.

The delivery ducts 8 of the double-acting piston compressor 1 comprise a redirection valve which places them fully or partially in communication with a reserve of compressed air, not depicted.

This reserve of compressed air consists, for example, of structural elements of the bodywork of a motor vehicle, said structural elements being rendered airtight.

The reserve of compressed air may serve to smooth the start-up of the compressor 1 when a demand for torque is received by the internal combustion engine 100, or to power pneumatic functions, for example on a motor vehicle, such as boosted braking or any other service rendered to the driver and/or his passengers.

The reserve of compressed air is connected to the intake of the internal combustion engine 100 by a large-diameter duct that can be opened or closed by means of a large bore section valve.

According to one particular embodiment, the reserve of compressed air constitutes a calming chamber limiting the amplitude of the pressure variations caused by the double-acting piston compressor 1 and by the cylinders 120 of the internal combustion engine 100.

The reserve of compressed air comprises a compressed air tapping for example allowing the motorist to reinflate his tires using a flexible line fitted with a pressure gage and appropriate connectors.

The delivery ducts 8 of the double-acting piston compressor 1 comprise a redirection valve, not depicted, which places them fully or partially in communication with a pressure drop housing.

The pressure drop housing allows additional engine braking to be created when the combustion engine 100 is used in a motor vehicle and also allows the catalytic converter of said vehicle to warm up more quickly by applying an additional workload to the engine allowing its exhaust temperature to increase.

The intake ducts 7 and/or the delivery ducts 8 of the double-acting piston compressor 1 comprise at least one throttling butterfly 112.

It will be noticed that the intake ducts 7 of the double-acting piston compressor 1 can be connected to an exhaust gas recirculation device of the combustion engine 100, known per se.

Likewise, the intake ducts 7 may comprise a cleaning fluid injector, it being possible for said injector periodically to inject pure water, water to which an additive has been added, or any other liquid capable of cleaning the inside of the compressor 1, namely the valves 90, 91, the intake 7 and delivery 8 ducts, the double-acting piston 4 and the cylinder 3.

As an alternative, the double-acting piston compressor 1 may comprise several stages, the double-acting pistons 4 of each cylinder 3 of the compressor 1 then being connected by an inter-piston linking rod such that the next double-acting piston 4 defines, with its cylinder 3, its intake 7 and delivery 8 ducts and its valves 90, 91, a new compressor stage mounted in series or in parallel with the stage before it.

The intake ducts 7 of the double-acting piston compressor 1 comprise at least one boost valve, not depicted, positioned upstream of and a certain distance away from the valve 90.

The intake ducts 7 of the double-acting piston compressor 1 are connected to the outlet of a centrifugal or rotary compressor, not depicted, which is driven for example by an electric motor.

The centrifugal compressor may be driven by a turbine driven by the exhaust gases from an internal combustion engine.

The double-acting piston 4 of the double-acting piston compressor 1 comprises a sealing rim 41 mounted radially free between at least two flanges 42, 43 (FIG. 5).

The sealing rim 41 may for example be made of a composite material, said material being capable of conforming to the geometry of the cylinder by wearing away against said cylinder until it has a shape that complements that of said cylinder so as to exhibit a minimum operating clearance to said cylinder.

The sealing rim 41 of the double-acting piston 4 has raised patterns 47 which create a pressure drop on its external cylindrical part (FIG. 5).

The sealing rim 41 comprises at least one upper seal 44 and/or one lower seal 45 creating a seal between said rim 41 and the flanges 42, 43 between which it is mounted (FIG. 5).

The double-acting piston 4 of the double-acting piston compressor 1 comprises a stack of sealing washers 46, said stack being mounted radially free between at least two flanges 42, 43 (FIG. 6).

The sealing washers 46 of the double-acting piston 4 have raised patterns 47 which create a pressure drop on their external cylindrical part (FIG. 6).

The first and/or the last sealing washer 46 of the double-acting piston 4 comprises (comprise) at least one seal 44, 45 creating a seal between said washer 46 and the flange 42, 43 with which it is in contact (FIG. 6).

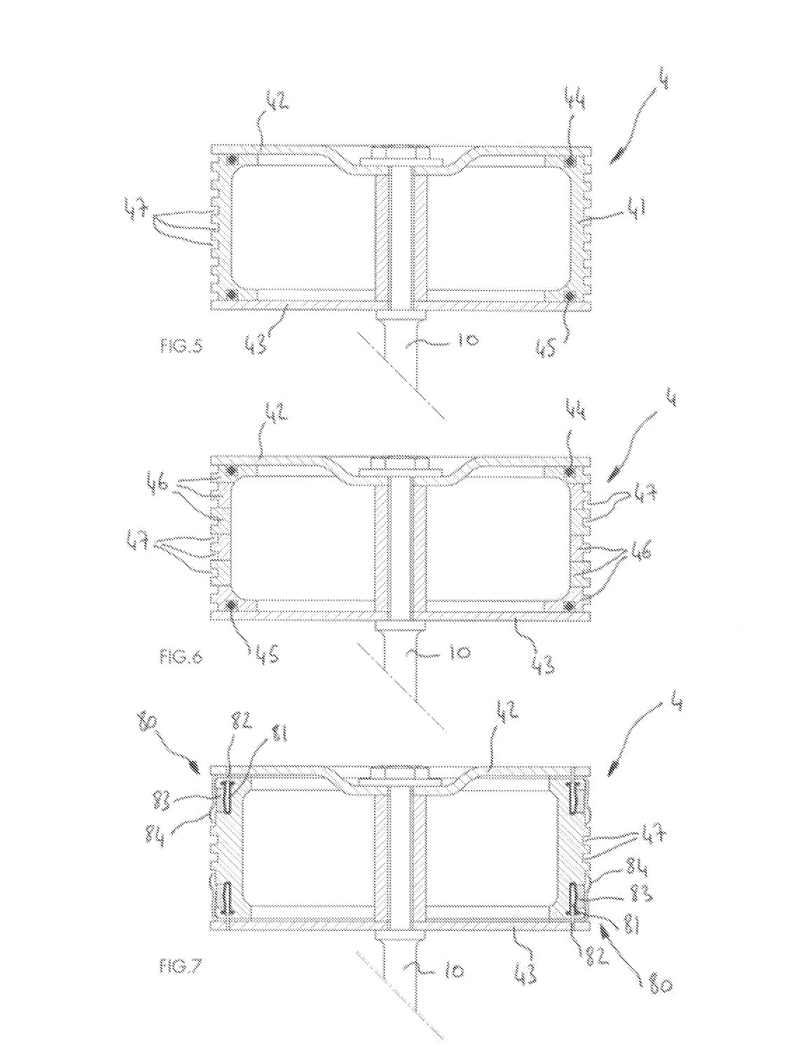

The double-acting piston 4 or the double-acting piston compressor 1 comprises at least one dynamic seal 80 at its periphery, of which the distance away from the cylinder 3 is slaved to the pressure obtaining in the upper 5 or lower 6 chamber, said dynamic seal 80 being able to come into contact with the cylinder 3 when the pressure in the chamber 5, 6 that is to be sealed is high enough (FIG. 7).

The dynamic seal 80 of the double-acting piston 4 comprises an air chamber 81 connected to one or other of the chambers 5, 6 by at least one duct 82, said air chamber 81 being able to apply a pressure to the internal cylindrical face of a constrictor ring 83 and said constrictor ring then being able to push a lip seal 84 toward the surface of the cylinder 3 until contact between said lip seal 84 and said cylinder 3 is assured.

It will be noted that the lip seal 84 may be replaced by an 0-ring, a composite seal or any other type of metallic or non-metallic seal.

The constrictor ring 83 of the dynamic seal 80 has a cut which comprises a limit stop that limits the maximum diameter of said constrictor ring.

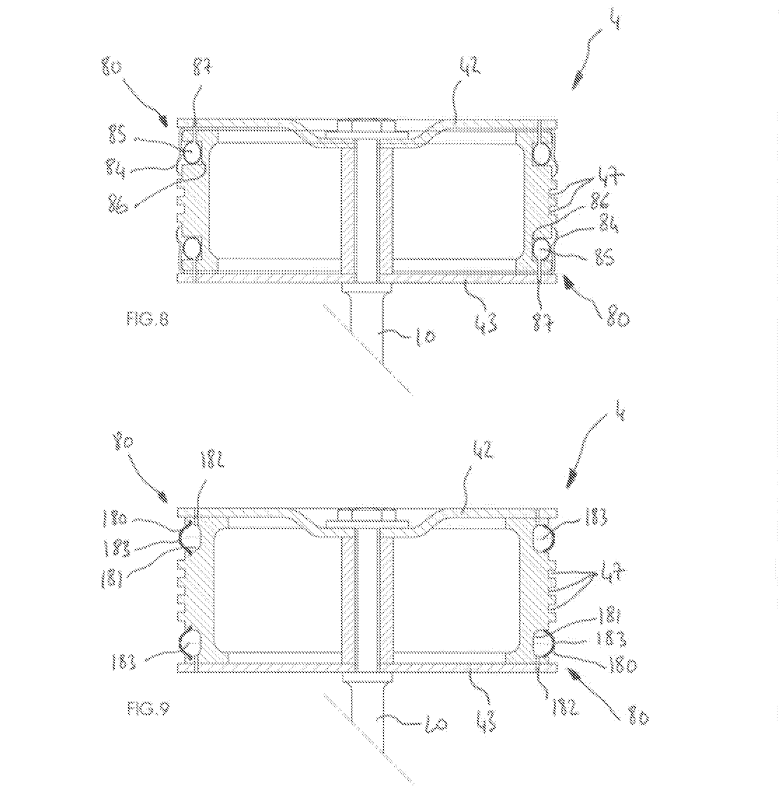

The dynamic seal 80 consists of a torus 85 made of a flexible material housed in a groove 86 with the upper and lower faces of which it forms a seal, the space between the back of the groove 86 and said torus 85 or inside said torus 85 being connected to one or other of the chambers 5, 6 by at least one duct 87 and said torus being able to push a lip seal 84 toward the surface of the cylinder 3 until contact between said lip seal 84 and said cylinder 3 is assured (FIG. 8).

The dynamic seal 80 consists of a toroidal bladder 180 made of a flexible material housed in a groove 181, said bladder 180 being connected to one or other of the chambers 5, 6 by at least one duct 182 so that it can inflate under the effect of the pressure so as to come into contact with the cylinder 3 (FIG. 9).

The bladder 180 on its exterior periphery comprises small holes 183 through which air under pressure can exit so as to constitute an air cushion to prevent direct contact between said bladder 180 and the cylinder 3 (FIG. 9).

The linking rod 10 of the double-acting piston compressor 1 collaborates with a guide device 101 positioned inside and/or under the cylinder head 33 which closes the lower end of the cylinder 3, said guide device 101 providing the radial positioning and axial orientation of said linking rod 10 (FIG. 4).

According to this particular embodiment, the exterior cylindrical face of the double-acting piston 4 no longer contributes toward either the positioning or the orienting of said piston.

In this case, the piston 4 does not come into contact with the cylinder 3 and this has the effect of limiting the friction losses of the double-acting piston compressor 1 according to the invention and of avoiding any risk of seizure between said piston 4 and said cylinder 3.

The linking rod 10 of the double-acting piston compressor 1 is connected to the transmission member 11 by a ball joint 102 (FIG. 4).

The ball joint 102 may, for example, be replaced by a Hooke's joint or by any other means of preventing translational movement while offering angular freedom about all three axes x, y and z.

The pivot pin 26 of the pinion 15 of the double-acting piston compressor 1 comprises a ball joint allowing said pinion 15 to self-orient freely about any one of the three axes of an orthonormal Cartesian frame of reference.

The cylinder 3 of the double-acting piston compressor 1 comprises a temperature equalizing chamber consisting of a space between a tube in which the double-acting piston 4 moves and an external casing, said space containing a heat transfer substance.

The heat transfer substance may, for example, consist of oil cohabiting with air or of a non-oxidizing neutral gas such as nitrogen or carbon dioxide, a mixture of water and of glycol, or of sodium salts.

The space needs, according to the invention, to be large enough to allow the heat transfer substance to effect convective movements favorable to evening out the temperature of the cylinder over its entire height and its entire circumference.

The delivery ducts 8 of the double-acting piston compressor 1 are connected to the intake duct(s) 111 of the internal combustion engine 100 via a calming device 130 consisting of a succession of at least one calming volume 132 connected together by at least one non return valve 131 (FIG. 11).

The calming device 130 is of especial benefit when the connecting rod 25 of the double-acting piston compressor 1 according to the invention is mounted on the crankshaft of a three-cylinder engine 100 and said compressor is used to supercharge said engine.

In such an instance, the double-acting piston compressor 1 generates four puffs of compressed air every two revolutions of the crankshaft, while the engine 100 admits only three of these during the same period of time.

The calming device 130 is therefore used to avoid excessive differences in filling between the cylinders of said engine 100. It will be noted that the succession of volumes and of valves may be replaced by or collaborate with one or more Helmholtz resonators known to those skilled in the art.

The pinion 15, the transmission member 11, the anchoring member 22, the guide roller 12 and the connecting rod 25 of the double-acting piston compressor 1 may be situated diametrically on the opposite side of the double-acting piston 4, of the cylinder 3 and of the cylinder heads 32, 33 from the crankshaft 27, the linking rod 10 being long enough to connect said transmission member 11 to said piston 4 in spite of the longer distance resulting from this configuration (FIG. 10).

Transmission between the double-acting piston compressor 1 and the internal combustion engine 100 is provided by rotational transmission means consisting of at least a chain and/or at least a belt and/or at least two pinions or sprockets.

The double-acting piston compressor 1 according to the present invention can be temporarily disconnected from the internal combustion engine (100) by means of a clutch positioned before or after the rotational transmission means.

The double-acting piston compressor 1 according to the present invention may comprise at least one balance shaft.

The double-acting piston compressor 1 according to the present invention may comprise at least one balance weight 250 connected to the crankshaft 27 by at least one balance rod 251, said balance rod 251 being articulated about the crankshaft 27 by means of a crank 252 which is offset by 180 degrees with respect to the crank to which the connecting rod 25 of the compressor is articulated.

The balance weight 250 is connected to the casing 110 of the compressor by at least one small anchor rod 253 so as to keep its movement approximately parallel to the axis of the cylinder 3 of the double-acting piston compressor 1.

The double-acting piston compressor 1 comprises at least one bypass valve 140 allowing connection between inlet (E) and outlet (S) ducts into which the intake 7 and delivery 8 ducts respectively open (FIG. 12).

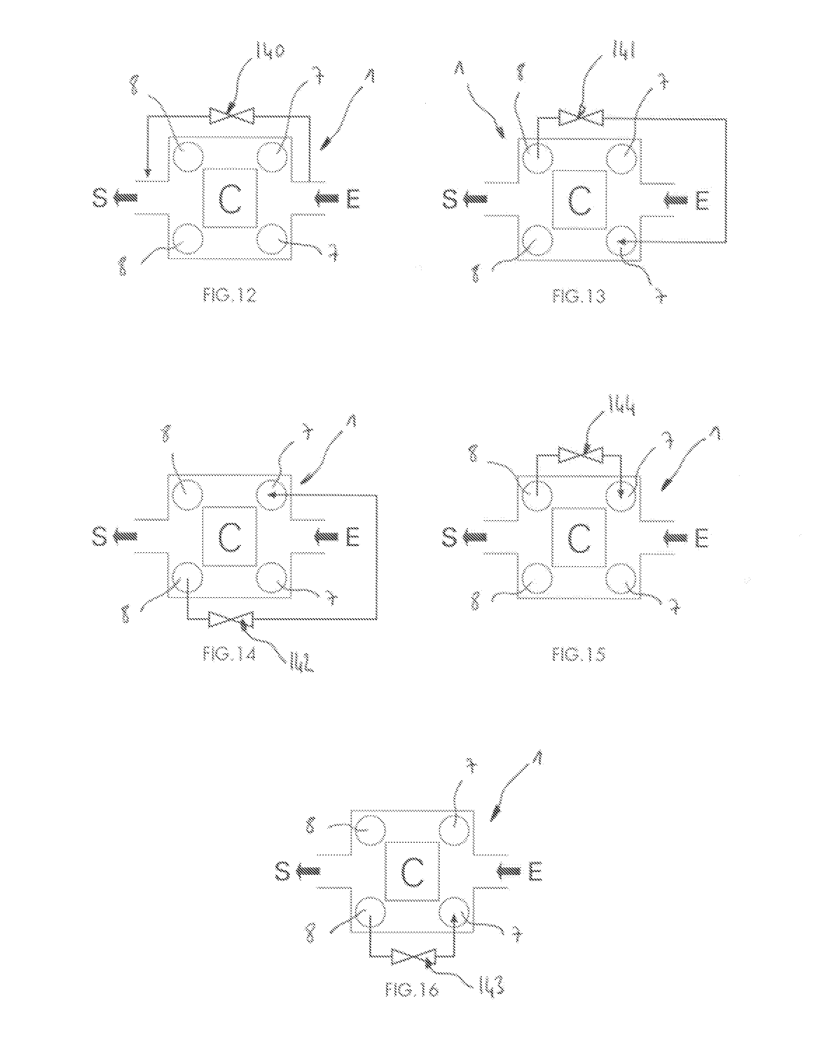

The double-acting piston compressor 1 comprises at least one bypass valve 141 allowing connection between the delivery duct 8 of the upper chamber 5 and the intake duct 7 of the lower chamber 6 (FIG. 13).

The double-acting piston compressor 1 comprises at least one bypass valve 142 allowing connection between the delivery duct 8 of the lower chamber 6 and the intake duct 7 of the upper chamber 5 (FIG. 14).

The double-acting piston compressor 1 comprises at least one bypass valve 143 allowing connection between the delivery duct 8 of the lower chamber 6 and the intake duct 7 of said lower chamber 6 (FIG. 16).

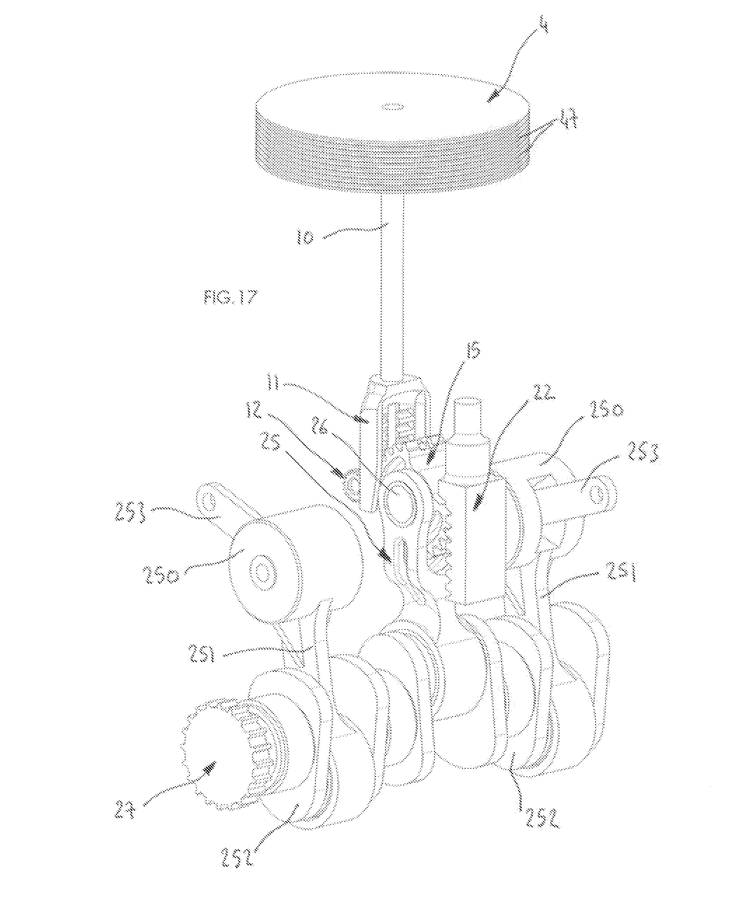

The double-acting piston compressor 1 comprises at least one bypass valve 144 allowing connection between the delivery duct 8 of the upper chamber 5 and the intake duct 7 of said upper chamber 5 (FIG. 15).

It will be noted that the various bypass valves 140, 141, 142, 143, 144 can be added together and combined with one another.

The double-acting piston compressor 1 comprises at least one isolation valve, not depicted, allowing the intake duct 7 of the upper chamber 5 and/or of the lower chamber 6 to be closed off.

The linking rod 10 of the double-acting piston compressor 1 collaborates with a labyrinth seal, not depicted, which provides a seal between the lower chamber 6 and the intake duct 7 of said chamber 6 or between said lower chamber 6 and the inside of the compressor casing 2.

How the Invention Works:

The way in which the double-acting piston compressor 1 according to the present invention works is as follows:

The crankshaft 27 of the compressor 1 is driven in rotation by a combustion engine or electric motor.

The connecting rod 25 connected to the crank of the crankshaft 27 therefore drives the pinion 15 in a vertical translational movement, said pinion 15 being in a mesh, on the one hand, with the large-sized anchoring rack 23 that the anchoring member 22 fixed to the compressor casing 2 comprises and, on the other hand, with the large-sized transmission rack 16 that the transmission member 11 comprises, said transmission member 11 itself being connected to the double-acting piston 4 by the linking rod 10.

This configuration has the effect of transmitting the movement of the connecting rod 25 to the double-acting piston 4. However, the stroke of the double-acting piston 4 is twice as long as that of the connecting rod 25 because the small end of said connecting rod is centered in the pinion 15.

However, there are various alternative kinematic relationships between the connecting rod 25 and the piston 4 that can be found if the axis of the small end of the connecting rod is no longer situated exactly at the center of the pinion 15 or if the position of the cylinder 3 of the compressor 1 with respect to that of the crankshaft 25 is altered.

The transmission member 11 is kept parallel to the cylinder 3 of the compressor 1 by the guide roller 12, the center thereof remaining at the same height as that of the pinion 15 thanks to the action of the small pinions 20 of said roller 12 which collaborate, on the one hand, with the small-sized racks 21 positioned on each side of the guidance runway track 19 of the compressor casing 2 and, on the other hand, with the small-sized synchronizing rack 14 that the transmission member 11 comprises.

The back and forth movement of the double-acting piston 4 in the cylinder 3 of the compressor 1 according to the invention causes a cyclic variation in the volume of the upper 5 and lower 6 chambers of said compressor.

Thus, each chamber 5, 6 draws in gas via the intake duct(s) 7 that the cylinder head 32, 33 of said chamber 5, 6 comprises, then delivers said gas via the delivery duct(s) 8 that said cylinder head 32, 33 also comprises.

During this cycle, the valve or valves 90 of the intake duct(s) 7 allow gas to enter the corresponding chamber 5, 6 but prevent it from leaving, whereas the valve(s) 91 of the delivery duct(s) 8 allow the gas to leave said corresponding chamber 5, 6 but prevent it from entering it.

During operation, the runway strips 17, 18, 24 that the transmission member 11, the pinion 15 and the anchoring member 22 of the compressor 1 according to the invention respectively comprise maintain the desired inter-axis distance between said pinion 15 and said transmission 11 and anchoring 22 members and allow the toothed sets that said pinion 15 and said transmission 11 and anchoring 22 members comprise to operate with the desired clearance.

The anchoring member 22 adopts the same orientation as the pinion 15 thanks to the ball joint or Hooke's joint or the component 50 with two offset perpendicular axes which keeps said anchoring member 22 in place in the compressor casing 2, these devices allowing said anchoring member 22 to self-orient in rotation but not to move translationally.

The runway strips 17, 18, 24 that the transmission member 11, the pinion 15 and the anchoring member 22 respectively comprise are further kept in contact by a pressure-maintaining device 60 which pushes against the exterior face of said anchoring member 22 such that the compressor 1 according to the invention remains quiet while it is running.

In the special case in which the compressor 1 according to the invention is used to supercharge an internal combustion engine 100, the delivery ducts 8 of said compressor 1 deliver the air into the intake duct(s) 111 of the engine 100.

According to one particular embodiment, the flow rate of air entering the compressor 1 is controlled by a throttling butterfly 112, while the temperature of the air leaving the compressor is reduced using a heat exchanger.

It must also be understood that the foregoing description has been given merely by way of example and does not in any way limit the scope of the invention and that replacing the embodiment details described by any other equivalent means would not constitute a departure from that scope.

1. Double-acting piston compressor of which the piston is guided by a roller (12) and driven by a pinion (15) and racks (16, 23), characterized in that the compressor comprises :
at least one cylinder (3) in which a double-acting piston (4) moves, said cylinder (3) being borne by a compressor casing (2) and each of its ends being closed by a cylinder head (32, 33), said cylinder (3) and said piston (4) jointly defining an upper chamber (5) and a lower chamber (6) each provided with at least one intake duct (7) and at least one delivery duct (8), and each duct comprising at least one valve (90, 91);
a linking rod (10) which connects the double-acting piston (4) to a transmission member (11), said transmission member (11) collaborating, on the one hand, with a guide roller (12) by means of at least one running surface (13) and by means of at least one small-sized synchronizing rack (14) and, on the other hand, with a pinion (15) by means of at least one large-sized transmission rack (16) and by means of at least one runway strip (17) positioned near the pitch circle of said large-sized transmission rack (16);
at least one runway strip (18) fixed onto or formed on the pinion (15), said runway strip (18) being positioned near the pitch circle of said pinion;
at least one guidance runway track (19) fixed to the compressor casing (2) level with the pinion (15) and along which the guide roller (12) rolls;
at least two small pinions (20) positioned one at each of the two ends of the guide roller (12) and which collaborate with small-sized racks (21) positioned one on each side of the guidance runway track (19) fixed to the compressor casing (2), one of the two small pinions (20) at least also collaborating with the small-sized synchronizing rack (14) that the transmission member (11) comprises;
at least one anchoring member (22) fixed to the compressor casing (2), said anchoring member (22) collaborating with the pinion (15) by means of at least one large-sized anchoring rack (23) and by means of at least one runway strip (24) positioned near the pitch circle of said large-sized anchoring rack (23);
a connecting rod (25) to the small end of which the pinion (15) is articulated by means of a pivot pin (26) and the big end of which is connected to the crank (28) of a crankshaft (27) housed in bearings formed in the compressor casing (2).

2. Double-acting piston compressor according to claim 1, characterized in that that part of the piston (4) in contact with the cylinder (3) has a spherical profile (40) that allows said piston to be oriented in said cylinder.

3. Double-acting piston compressor according to claim 1, characterized in that the double-acting piston (4) has at least one piston ring or one seal which seals it against the cylinder (3).

4. Double-acting piston compressor according to claim 1, characterized in that the double-acting piston (4) has raised patterns which create a pressure drop on the cylindrical part of said piston.

5. Double-acting piston compressor according to claim 1, characterized in that the interior surface (30) of the cylinder (3) comprises raised patterns which create a pressure drop.

6. Double-acting piston compressor according to claim 1, characterized in that the double-acting piston (4) is fixed to the end of the linking rod (10) by means of a ball joint.

7. Double-acting piston compressor according to claim 1, characterized in that the linking rod (10) has at least one ring or one seal which seals it against the cylinder head (33) of the lower chamber (6) of the compressor (1).

8. Double-acting piston compressor according to claim 1, characterized in that the linking rod (10) has at least one ring or one seal which seals it against the compressor casing (2).

9. Double-acting piston compressor according to claim 1, characterized in that the anchoring member (22) has an upper or lower anchoring rod (29) the end of which is fixed to the compressor casing (2).

10. Double-acting piston compressor according to claim 1, characterized in that the anchoring member (22) is fixed to the compressor casing (2) by means of a ball joint.

11. Double-acting piston compressor according to claim 10, characterized in that the ball joint is positioned above or below the anchoring member (22).

12. Double-acting piston compressor according to claim 1, characterized in that the anchoring member (22) comprises stiffening webs on each side of its large-sized anchoring rack (23).

13. Double-acting piston compressor according to claim 1, characterized in that the anchoring member (22) is fixed to the compressor casing (2) by means of a joint that has two perpendicular pivot pins of the Hooke's joint type.

14. Double-acting piston compressor according to claim 1, characterized in that the anchoring member (22) is fixed to the compressor casing by means of a component (50) with two offset perpendicular pivot pins, the first pivot pin (51) being articulated to said anchoring member (22), while the second pivot pin (52) is articulated to the compressor casing (2).

15. Double-acting piston compressor according to claim 14, characterized in that the second pivot pin (52) of the component (50) that has two offset perpendicular pivot pins comprises a limit stop (53) that allows adjustment of the verticality of the anchoring member (22).

16. Double-acting piston compressor according to claim 15, characterized in that the limit stop (53) that allows adjustment of the verticality of the anchoring member (22) is screwed into the compressor casing (2) and prevented from turning by locking means (54).

17. Double-acting piston compressor according to claim 1, characterized in that the anchoring member (22) comprises means of adjusting its vertical position with respect to the compressor casing (2).

18. Double-acting piston compressor according to claim 1, characterized in that the runway strip (24) of the anchoring member (22) is kept in contact with the runway strip (18) of the pinion (15) by a pressure-maintaining device (60).

19. Double-acting piston compressor according to claim 18, characterized in that the pressure-maintaining device (60) consists of a spring.

20. Double-acting piston compressor according to claim 18, characterized in that the pressure-maintaining device (60) consists of a pressing actuator (61) connected to a pressure accumulator.

21. Double-acting piston compressor according to claim 1, characterized in that the pinion (15) has a truncated profile defining two toothed sectors (150, 151).

22. Double-acting piston compressor according to claim 1, characterized in that the pinion (15) has weight-saving pockets (152) and stiffening ribs.

23. Double-acting piston compressor according to claim 1, characterized in that the pivot pin (26) by means of which the pinion (15) is articulated to the small end of the connecting rod (25) is housed in bores formed in said pinion (15) on each side of a recess, said recess housing the small end of the connecting rod.

24. Double-acting piston compressor according to claim 1, characterized in that the pivot pin (26) by means of which the pinion (15) is articulated to the small end of the connecting rod (25) is housed in bores formed in a fork that forms the small end of the connecting rod, said pinion (15) being housed in the crook of said fork.

25. Double-acting piston compressor according to claim 1, characterized in that the transmission member (11) comprises stiffening webs on each side of its large-sized transmission rack (16).

26. Double-acting piston compressor according to claim 1, characterized in that the guidance runway track (19) and the small-sized racks (21) positioned on each side of said track are borne by a synchronizing plate (70) fixed to the compressor casing (2).

27. Double-acting piston compressor according to claim 26, characterized in that at least one adjusting shim is inserted between the synchronizing plate (70) and the compressor casing (2).

28. Double-acting piston compressor according to claim 1, characterized in that said double-acting piston compressor (1) is mounted on a fixed compression ratio or variable compression ratio internal combustion engine (100).

29. Double-acting piston compressor according to claim 28, characterized in that the crankshaft (27) of the compressor (1) is produced in the continuation of the crankshaft of an internal combustion engine (100) and forms an integral part thereof.

30. Double-acting piston compressor according to claim 28, characterized in that the delivery ducts (8) of the compressor (1) are connected to the intake duct(s) (111) of the internal combustion engine (100).

31. Double-acting piston compressor according to claim 28, characterized in that the compressor casing (2) of the compressor (1) is attached to the crankcase (110) of the internal combustion engine (100).

32. Double-acting piston compressor according to claim 28, characterized in that the compressor casing (2) of the compressor (1) forms an integral part of the crankcase (110) of the internal combustion engine (100).

33. Double-acting piston compressor according to claim 28, characterized in that all or part of the cylinder (3), of the cylinder heads (32, 33) and of the intake (7) and delivery (8) ducts of the compressor (1) form an integral part of the cylinder head of the internal combustion engine (100).

34. Double-acting piston compressor according to claim 28, characterized in that all or part of the cylinder (3), of the cylinder heads (32, 33) and of the intake (7) and delivery (8) ducts of the compressor (1) form an integral part of the crankcase (110) of the internal combustion engine (100).

35. Double-acting piston compressor according to claim 28, characterized in that the compressor casing (2) of the compressor (1) comprises a cooling water circuit connected to that of the internal combustion engine (100).

36. Double-acting piston compressor according to claim 28, characterized in that the delivery ducts (8) of the compressor (1) comprise a redirection valve which places them fully or partially in communication with a reserve of compressed air.

37. Double-acting piston compressor according to claim 36, characterized in that the reserve of compressed air consists of structural elements of the bodywork of a motor vehicle, said structural elements being rendered airtight.

38. Double-acting piston compressor according to claim 36, characterized in that the reserve of compressed air is connected to the intake of the internal combustion engine (100) by a large-diameter duct that can be opened or closed by means of a large bore section valve.

39. Double-acting piston compressor according to claim 36, characterized in that the reserve of compressed air comprises a compressed air tapping.

40. Double-acting piston compressor according to claim 28, characterized in that the delivery ducts (8) of the compressor (1) comprise a redirection valve which places them fully or partially in communication with a pressure drop housing.

41. Double-acting piston compressor according to claim 28, characterized in that the intake ducts (7) of the compressor (1) comprise at least one throttling butterfly (112).

42. Double-acting piston compressor according to claim 28, characterized in that the delivery ducts (8) of the compressor (1) comprise at least one throttling butterfly.

43. Double-acting piston compressor according to claim 1, characterized in that the valves (90, 91) comprise an impact damper and/or limiter.

44. Double-acting piston compressor according to claim 43, characterized in that the impact damper and/or limiter is an elastic link between the body of the valve (90, 91) and the bearing surface via which the valve shutter rests against its seat.

45. Double-acting piston compressor according to claim 1, characterized in that the double-acting pistons (4) of each cylinder (3) of the compressor (1) are connected by an inter-piston linking rod, the next double-acting piston (4) defining, with its cylinder (3), its intake (7) and delivery (8) ducts and its valves (90, 91), a new compressor stage mounted in series or in parallel with the stage before it.

46. Double-acting piston compressor according to claim 1, characterized in that the intake ducts (7) of the compressor (1) comprise at least one boost valve positioned upstream of and a certain distance away from the valve (90).

47. Double-acting piston compressor according to claim 1, characterized in that the intake ducts (7) of the compressor (1) are connected to the outlet of a centrifugal or rotary compressor.

48. Double-acting piston compressor according to claim 47, characterized in that the centrifugal compressor is driven by an electric motor.

49. Double-acting piston compressor according to claim 47, characterized in that the centrifugal compressor is driven by a turbine driven by the exhaust gases from an internal combustion engine.

50. Double-acting piston compressor according to claim 1, characterized in that the double-acting piston (4) comprises a sealing rim (41) mounted radially free between at least two flanges (42, 43).

51. Double-acting piston compressor according to claim 50, characterized in that the sealing rim (41) has raised patterns (47) which create a pressure drop on its external cylindrical part.

52. Double-acting piston compressor according to claim 50, characterized in that the sealing rim (41) comprises at least one upper seal (44) and/or one lower seal (45) creating a seal between said rim (41) and the flanges (42, 43) between which it is mounted.

53. Double-acting piston compressor according to claim 1, characterized in that the double-acting piston (4) comprises a stack of sealing washers (46), said stack being mounted radially free between at least two flanges (42, 43).

54. Double-acting piston compressor according to claim 53, characterized in that the sealing washers (46) have raised patterns (47) which create a pressure drop on their external cylindrical part.

55. Double-acting piston compressor according to claim 53, characterized in that the first and/or the last sealing washer (46) comprises (comprise) at least one seal (44, 45) creating a seal between said washer (46) and the flange (42, 43) with which it is in contact.

56. Double-acting piston compressor according to claim 1, characterized in that the double-acting piston (4) comprises at least one dynamic seal (80) at its periphery, of which the distance away from the cylinder (3) is slaved to the pressure obtaining in the upper (5) or lower (6) chamber, said dynamic seal (80) being able to come into contact with the cylinder (3) when the pressure in the chamber (5, 6) that is to be sealed is high enough.

57. Double-acting piston compressor according to claim 56, characterized in that the dynamic seal (80) comprises an air chamber (81) connected to one or other of the chambers (5, 6) by at least one duct (82), said air chamber (81) being able to apply a pressure to the internal cylindrical face of a constrictor ring (83) and said constrictor ring then being able to push a lip seal (84) toward the surface of the cylinder (3) until contact between said lip seal (84) and said cylinder (3) is assured.

58. Double-acting piston compressor according to claim 57, characterized in that the constrictor ring (83) has a cut which comprises a limit stop that limits the maximum diameter of said constrictor ring.

59. Double-acting piston compressor according to claim 56, characterized in that the dynamic seal (80) consists of a torus (85) made of a flexible material housed in a groove (86) with the upper and lower faces of which it forms a seal, the space between the back of the groove (86) and said torus (85) or inside said torus (85) being connected to one or other of the chambers (5, 6) by at least one duct (87) and said torus being able to push a lip seal (84) toward the surface of the cylinder (3) until contact between said lip seal (84) and said cylinder (3) is assured.

60. Double-acting piston compressor according to claim 56, characterized in that the dynamic seal (80) consists of a toroidal bladder (180) made of a flexible material housed in a groove (181), said bladder (180) being connected to one or other of the chambers (5, 6) by at least one duct (182) so that it can inflate under the effect of the pressure so as to come into contact with the cylinder (3).

61. Double-acting piston compressor according to claim 60, characterized in that the bladder (180) on its exterior periphery comprises small holes (183) through which air under pressure can exit so as to constitute an air cushion to prevent direct contact between said bladder (180) and the cylinder (3).

62. Double-acting piston compressor according to claim 1, characterized in that the linking rod (10) collaborates with a guide device (101) positioned inside and/or under the cylinder head (33) which closes the lower end of the cylinder (3), said guide device (101) providing the radial positioning and axial orientation of said linking rod (10).

63. Double-acting piston compressor according to claim 1, characterized in that the linking rod (10) is connected to the transmission member (11) by a ball joint (102).

64. Double-acting piston compressor according to claim 1, characterized in that the pivot pin (26) comprises a ball joint allowing the pinion (15) to self-orient freely about any one of the three axes of an orthonormal Cartesian frame of reference.

65. Double-acting piston compressor according to claim 1, characterized in that the cylinder (3) comprises a temperature equalizing chamber consisting of a space between a tube in which the double-acting piston (4) moves and an external casing, said space containing a heat transfer substance.

66. Double-acting piston compressor according to claim 30, characterized in that the delivery ducts (8) of the compressor (1) are connected to the intake duct(s) (111) of the internal combustion engine (100) via a calming device (130) consisting of at least one calming volume (132) comprising at least one non return valve (131).

67. Double-acting piston compressor according to claim 1, characterized in that the pinion (15), the transmission member (11), the anchoring member (22), the guide roller (12) and the connecting rod (25) are situated diametrically on the opposite side of the double-acting piston (4), of the cylinder (3) and of the cylinder heads (32, 33) from the crankshaft (27), the linking rod (10) being long enough to connect said transmission member (11) to said piston (4) in spite of the longer distance resulting from this configuration.

68. Double-acting piston compressor according to claim 28, characterized in that transmission between the double-acting piston compressor (1) and the internal combustion engine (100) is provided by rotational transmission means consisting of at least a chain and/or at least a belt and/or at least two pinions or sprockets.

69. Double-acting piston compressor according to claim 68, characterized in that it can be temporarily disconnected from the internal combustion engine (100) by means of a clutch positioned before or after the rotational transmission means.

70. Double-acting piston compressor according to claim 1, characterized in that it comprises at least one balance shaft.

71. Double-acting piston compressor according to claim 1, characterized in that it comprises at least one balance weight (250) connected to the crankshaft (27) by at least one balance rod (251), said balance rod (251) being articulated about the crankshaft (27) by means of a crank (252) which is offset by 180 degrees with respect to the crank to which the connecting rod (25) of the compressor is articulated.

72. Double-acting piston compressor according to claim 71, characterized in that the balance weight (250) is connected to the casing (110) of the compressor by at least one small anchor rod (253) so as to keep its movement approximately parallel to the axis of the cylinder (3) of the compressor (1).

73. Double-acting piston compressor according to claim 1, characterized in that it comprises at least one bypass valve (140) allowing connection between inlet (E) and outlet (S) ducts into which the intake (7) and delivery (8) ducts respectively open.

74. Double-acting piston compressor according to claim 1, characterized in that it comprises at least one bypass valve (141) allowing connection between the delivery duct (8) of the upper chamber (5) and the intake duct (7) of the lower chamber (6).

75. Double-acting piston compressor according to claim 1, characterized in that it comprises at least one bypass valve (142) allowing connection between the delivery duct (8) of the lower chamber (6) and the intake duct (7) of the upper chamber (5).

76. Double-acting piston compressor according to claim 1, characterized in that it comprises at least one bypass valve (143) allowing connection between the delivery duct (8) of the lower chamber (6) and the intake duct (7) of said lower chamber (6).

77. Double-acting piston compressor according to claim 1, characterized in that it comprises at least one bypass valve (144) allowing connection between the delivery duct (8) of the upper chamber (5) and the intake duct (7) of said upper chamber (5).

78. Double-acting piston compressor according to claim 1, characterized in that it comprises at least one isolation valve allowing the intake duct (7) of the upper chamber (5) and/or of the lower chamber (6) to be closed off.

79. Double-acting piston compressor according to claim 1, characterized in that the linking rod (10) collaborates with a labyrinth seal which provides a seal between the lower chamber (6) and the intake duct (7) of said chamber (6) or between said lower chamber (6) and the inside of the compressor casing (2).
